(19) United States
(12) Patent Application Publication
(10) Pub. No.: US 2021/0089904 A1
(43) Pub. Date: Mar. 25, 2021

(54) LEARNING METHOD OF NEURAL NETWORK MODEL FOR LANGUAGE GENERATION AND APPARATUS FOR PERFORMING THE LEARNING METHOD

(71) Applicant: Electronics and Telecommunications Research Institute, Daejeon (KR)

(72) Inventors: Eui Sok CHUNG, Daejeon (KR); Hyun Woo KIM, Daejeon (KR); Hwa Jeon SONG, Daejeon (KR); Yoo Rhee OH, Daejeon (KR); Byung Hyun YOO, Daejeon (KR); Ran HAN, Daejeon (KR)

(73) Assignee: Electronics and Telecommunications Research Institute, Daejeon (KR)

(21) Appl. No.: 17/024,062

(22) Filed: Sep. 17, 2020

(30) Foreign Application Priority Data
Sep. 20, 2019 (KR) 10-2019-0116105
Aug. 31, 2020 (KR) 10-2020-0110295

(51) Int. Cl. G06N 3/08; G06N 3/04; G06F 17/18

(52) U.S. Cl. CPC G06N 3/08; G06F 17/18; G06N 3/04

(57) ABSTRACT

The present invention provides a new learning method where regularization of a conventional model is reinforced by using an adversarial learning method. Also, a conventional method has a problem of word embedding having only a single meaning, but the present invention solves a problem of the related art by applying a self-attention model.

### CROSS-REFERENCE TO RELATED APPLICATIONS

This application claims priority under 35 U.S.C. § 119 to Korean Patent Application No. 10-2019-0116105, filed on Sep. 20, 2019 and Korean Patent Application No. 10-2020-0110295, filed on Aug. 31, 2020, the disclosure of which is incorporated herein by reference in its entirety.

### TECHNICAL FIELD

The present invention relates to language generating technology based on a neural network.

### BACKGROUND

Recently, research is being actively performed on technology (hereinafter referred to as neural network-based language generation or neural language generation) for generating a language (or a natural language) by using a neural network.

In a neural network model for neural network-based language generation, regularization of output values (i.e., a softmax function for calculating a language generation probability value) of a neural network is used for classifying classes of the output values of the neural network.

However, the softmax function has a problem where a number of operations are needed for calculating a language generation probability value, and a problem of a softmax operation is a main cause which decreases a learning speed and performance of a neural network model for neural network-based language generation.

### SUMMARY

Accordingly, the present invention is for improving a learning speed and performance of a neural network model for neural network-based language generation.

In detail, the present invention is for solving a problem of a softmax function of calculating a language generation probability value. Also, the present invention provides an attention model which considers a context of a sentence at a language generation time so as to improve performance.

In one general aspect, a learning method of a neural network model for language generation, performed by at least one processor of a computing device, includes: adding, by using an adder block, an adversarial perturbation value to each of an input word embedding value, where an input word is expressed as a vector, and a target word embedding value where a right answer word appearing next to the input word is expressed as a vector; performing, by using a recurrent neural network (RNN) block, an RNN operation on an input word embedding value with the adversarial perturbation value added thereto to calculate a hidden value; performing, by using a self-attention model, a self-attention operation on the calculated hidden value to project context information about a peripheral word of the input word onto the calculated hidden value; and performing, by using a distance minimization calculator, adversarial learning on the neural network model through an operation of minimizing a distance value between a hidden value with the context information projected thereon and a target word embedding value with the adversarial perturbation value added thereto.

In another general aspect, a computing device for performing learning of a neural network model includes: a storage medium storing the neural network model; and a processor connected to the storage medium to execute the neural network model stored in the storage medium, wherein the processor includes: a first operational logic adding an adversarial perturbation value to each of an input word embedding value, where an input word is expressed as a vector, and a target word embedding value where a right answer word appearing next to the input word is expressed as a vector; a second operational logic performing a recurrent neural network (RNN) operation on an input word embedding value with the adversarial perturbation value added thereto to calculate a hidden value; a third operational logic performing a self-attention operation on the calculated hidden value to project context information about a peripheral word of the input word onto the calculated hidden value; and a fourth operational logic performing adversarial learning on the neural network model through an operation of minimizing a distance value between a hidden value with the context information projected thereon and a target word embedding value with the adversarial perturbation value added thereto.

Other features and aspects will be apparent from the following detailed description, the drawings, and the claims.

### BRIEF DESCRIPTION OF THE DRAWINGS

FIG. 1 is a block diagram illustrating an internal configuration of a neural network model for neural network-based language generation, according to an embodiment of the present invention.

FIG. 2 is a diagram schematically illustrating a learning process for neural network-based language generation, according to an embodiment of the present invention.

FIG. 3 is a flowchart for describing a learning method of a neural network model for language generation, according to an embodiment of the present invention.

### DETAILED DESCRIPTION OF EMBODIMENTS

Hereinafter, example embodiments of the present invention will be described in detail with reference to the accompanying drawings. Embodiments of the present invention are provided so that this disclosure will be thorough and complete, and will fully convey the concept of the present invention to one of ordinary skill in the art. Since the present invention may have diverse modified embodiments, preferred embodiments are illustrated in the drawings and are described in the detailed description of the present invention. However, this does not limit the present invention within specific embodiments and it should be understood that the present invention covers all the modifications, equivalents, and replacements within the idea and technical scope of the present invention. Like reference numerals refer to like elements throughout.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In various embodiments of the disclosure, the meaning of ‘comprise’, ‘include’, or ‘have’ specifies a property, a region, a fixed number, a step, a process, an element and/or a component but does not exclude other properties, regions, fixed numbers, steps, processes, elements and/or components.

Hereinafter, embodiments of the present invention will be described in detail with reference to the accompanying drawings. First, in order to help understand the present invention, some researches known to those skilled in the art will be described in association with neural network-based language generation.

In the paper (hereinafter referred to as Kumar's paper) ‘VON MISES-FISHER LOSS FOR TRAINING SEQUENCE TO SEQUENCE MODELS WITH CONTINUOUS OUTPUTS’ disclosed in ICLR 2019 and presented by Sachin Kumar & Yulia Tsvetkov, continuous output technology using Von Mises-Fisher (vMF) loss is described.

The Kumar's paper has proposed an access method of directly generating word embedding value instead of generating a probability distribution of vocabulary generation in an output step of a sequence-to-sequence model.

In detail, the Kumar's paper has proposed a learning process which is performed for minimizing a distance between an output vector of a neural network and a target word (i.e., a pre-trained word embedding vector)

In the Kumar's paper, a generation vector (i.e., an output vector value) of a model may be used as a key in searching for nearest neighbor in a target embedding space at a test time.

The present invention proposes new von Mises-Fisher (vMF) loss by using an adversarial training technique or an adversarial learning technique, for new regularization of vMF loss.

Moreover, the present invention proposes a language generation access method which considers a context of a sentence by using a self-attention model in a process of calculating a distance between a pre-trained word embedding value and an output vector value.

In regard to neural network-based language generation, the paper (hereinafter referred to as Goodfellow's paper) ‘EXPLAINING AND HARNESSING ADVERSARIAL EXAMPLES’, disclosed in ICLR 2015 and presented by Ian J. Goodfellow, Jonathon Shlens & Christian Szegedy, describes a fast gradient sign method (FGSM) for improving robustness of a model by applying a worst-case perturbation value to input data of a learning model.

The present invention proposes a method which applies an adversarial training technique or an adversarial learning technique to vMF loss by estimating an output vector value and an adversarial perturbation value in addition to applying a perturbation value to input data of a learning model, based on the Goodfellow's paper.

In regard to neural network-based language generation, in the paper (hereinafter referred to as Vaswani's paper) ‘Attention Is All You Need’, disclosed in 31^{st} conference (NIPS 2017) for a neural information processing system and presented by Ashish Vaswani and more authors, describes a multi-head attention model configured with self-attention and sequence to sequence.

The Vaswani's paper describes an access method which increases the number of parameters of an attention model to reinforce an attention ability of a model. The present invention proposes an access method for replacing a multi-head attention model on the basis of an access method described in the paper ‘Deep Residual Output Layers for Neural Language Generation’ disclosed in Proceedings of the 36th International Conference on Machine Learning and presented by Nikolaos Pappas.

In a conventional attention model, there is no shared parameter between attention items, and thus, independent attentions are generated.

In neural language generation technology, an access method (the Kumar's paper) has been proposed where an output layer of a decoder does not generate a probability distribution but outputs a word embedding value.

The access method of the Kumar's paper is an access method where dependency is large for word embedding. That is, the access method of the Kumar's paper has a problem of word embedding having only a single meaning. In order to solve such a problem, the present invention proposes a method which merges a context-based attention model with the access method (the Kumar's paper).

Moreover, the present invention provides a new learning method of reinforcing regularization of a conventional model by using an adversarial learning method.

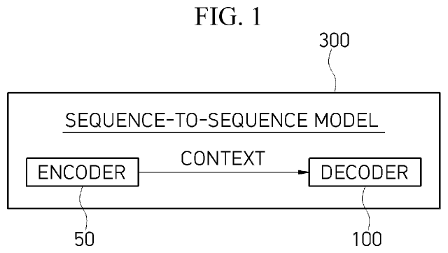

FIG. 1 is a block diagram illustrating an internal configuration of a neural network model for neural network-based language generation, according to an embodiment of the present invention.

Referring to FIG. 1, the neural network model for neural network-based language generation according to an embodiment of the present invention may be, for example, a sequence-to-sequence model 300.

The sequence-to-sequence model 300 may be implemented as a software module, a hardware module, or a combination thereof, which is executed by a computing device.

When the sequence-to-sequence model 300 is implemented as a software module, the sequence-to-sequence model 300 may be implemented as an algorithm which is executed by at least one of a computing device and is installed in a memory of the computing device for execution. Here, the processor may be at least one central processing unit (CPU), at least one graphics processing unit (GPU), or a combination thereof.

When the sequence-to-sequence model 300 is implemented as a hardware module, the sequence-to-sequence model 300 may be implemented as a circuit logic of at least one processor of a computing device.

The sequence-to-sequence model 300 may be a model of which outputs an output sequence of another domain from an input sequence and may be applied to various fields such as Chatbot, machine translation, text summarization, and speech to text.

The sequence-to-sequence model 300, as illustrated in FIG. 1, may include an encoder 150 and a decoder 100.

The encoder 50 may sequentially receive all words of an input sentence and may encode the received words as one vector. The vector encoded by the encoder 50 may be referred to as a context vector.

When all words of the input sentence are encoded as one context vector, the encoder 50 may input the context vector to the decoder 100.

The decoder 100 may sequentially output, one by one, each of translated words on the basis of the context vector input from the encoder 50.

Although the present embodiment is not limited, it may be assumed that a language generation process according to an embodiment of the present invention is applied to the decoder 100 of the sequence-to-sequence model 300.

The language generation process according to an embodiment of the present invention applied to the decoder 100 may provide a new access method where an adversarial training technique and self-attention technology are applied to a vMF loss access method.

The language generation process according to an embodiment of the present invention applied to the decoder 100 may solve a problem of an independent access method between attention items, which is a limitation of a conventional attention model.

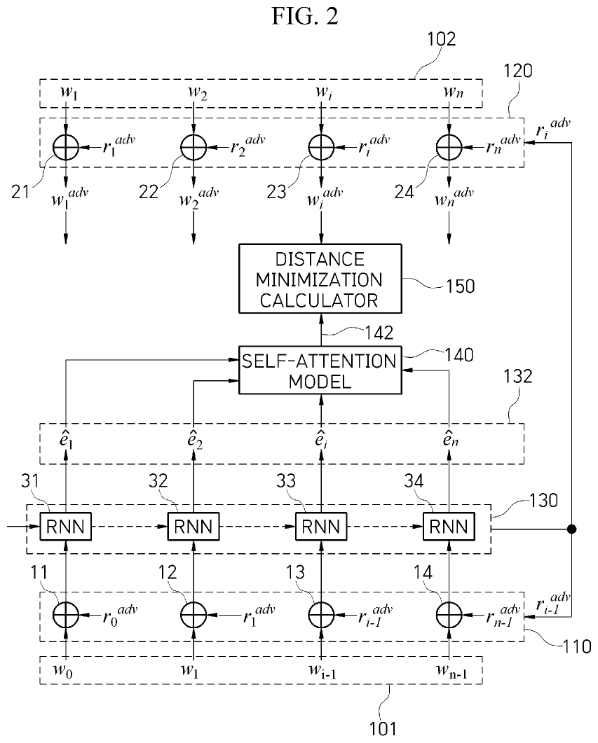

FIG. 2 is a diagram schematically illustrating a learning process for language generation by the decoder illustrated in FIG. 1.

Referring to FIG. 2, the decoder 100 may include two adder blocks 110 and 120, a recurrent neural network (RNN) block 130, a self-attention model 140, and a distance minimization calculator 150, for learning of the decoder 100.

Each of the elements 110 to 150 may be implemented as a software module executed by a processor of a computing device, or may be implemented as a circuit logic (a hardware module) embedded into the processor. Alternatively, each of the elements 110 to 150 may be implemented as a combination of a software module and a hardware module.

The adder block 110 may include a plurality of adders 11 to 14. Each of the adders 11 to 14 may summate an input word embedding value (wᵢ₋₁ of 101), where an input word is expressed as a vector, and an adversarial perturbation value (rᵢ₋₁^{adv}) estimated by an RNN cell 33 to convert the input word embedding value (wᵢ₋₁ of 101) into an input word embedding value 115 with the adversarial perturbation value (rᵢ₋₁^{adv}) reflected therein.

The adder block 120 may include a plurality of adders 21 to 24. For example, each of the adders 21 to 24 may summate a target word embedding value (wᵢ₋₁ of 102), where a right answer word appearing next to an input word is expressed as a vector, and an adversarial perturbation value (rᵢ^{adv}) estimated by the RNN cell 33 to convert the target word embedding value wᵢ₋₁ of 102) into a target word embedding value (wᵢ^{adv}) with the adversarial perturbation value reflected therein.

The RNN block 130 may include a plurality of RNN cells 31 to 34 and may output a hidden value (êᵢ of 132) with the adversarial perturbation value (rᵢ₋₁^{adv}) reflected therein. For example, the RNN cell 33 may perform an RNN operation (or a hidden layer operation) on the input word embedding value 115 with the adversarial perturbation value) (rᵢ₋₁^{adv}) reflected therein to generate the hidden value (êᵢ of 132) with the adversarial perturbation value (rᵢ₋₁^{adv}) reflected therein.

Moreover, the RNN block 130 may estimate the adversarial perturbation value (rᵢ₋₁^{adv}) before outputting the hidden value (êᵢ of 132) with the adversarial perturbation value) (rᵢ₋₁^{adv}) reflected therein.

In order to estimate an adversarial perturbation value, for example, the RNN cell 33 may perform decoding inference (or an RNN operation) on the input word embedding value (wᵢ₋₁ of 101) passing through the adder 13 to generate an initial hidden value and may output (or estimate) the initial hidden value as an adversarial perturbation value (rᵢ₋₁^{adv}, rᵢ^{adv}).

Subsequently, the adder 13 may add the adversarial perturbation value (rᵢ₋₁^{adv}), estimated by the RNN cell 33, to word embedding values (wᵢ₋₁), and the adder 23 may add the adversarial perturbation value (rᵢ^{adv}) estimated by the RNN cell 33, to word embedding values (wᵢ).

The self-attention model 140 may perform an self-attention operation on the hidden value (êᵢ of 132) with the adversarial perturbation value (rᵢ₋₁^{adv}) reflected therein to project context information, representing meaning variation based on a context, onto the hidden value (êᵢ of 132).

The context information may denote previous words and next words with respect to a current word corresponding to a self-attention operation target. When the current word is assumed to be the hidden value (êᵢ of 132) estimated by (or output from) the RNN cell 33, the previous words may be ê₁, ê₂, . . . êᵢ₋₁ of 132, and the next words may be êᵢ₊₁ . . . êₙ of 132.

According to an embodiment of the present invention, before the distance minimization calculator 150 to be described below performs a comparison operation on an output value (for example, the hidden value (êᵢ of 132) with the adversarial perturbation value (rᵢ₋₁^{adv}) reflected therein) of the RNN block 130 and the target word embedding value (wᵢ^{adv}) with the adversarial perturbation value (rᵢ^{adv}) reflected therein, the self-attention model 140 may project context information, representing meaning variation (context information) based on a context, onto the hidden value (êᵢ of 132), and thus, the present invention may have a difference with prior art documents.

The distance minimization calculator 150 may perform an operation of minimizing a distance value between a hidden value 142 with the context information projected thereon and the target word embedding value (wᵢ^{adv}) with the adversarial perturbation value (rᵢ^{adv}) reflected therein to perform adversarial learning on the neural network model (the decoder).

Hereinafter, each of the elements 110 to 150 will be described in more detail.

When w₀ w₁ . . . wᵢ₋₁ are assigned as a previous context in a process of generating one sentence, the decoder may model, a probability of a word wᵢ which may appear subsequently, into a model p(wᵢ|w₀ w₁ . . . wᵢ₋₁).

An input of wᵢ₋₁ the decoder 100 may be an input word embedding value and may be assumed to be a pre-trained or pre-learned value. Here, the input word embedding value may be referred to as an input word embedding vector. Similarly, a target word embedding vector to be described below may be referred to as a target word embedding vector.

The RNN block 130 may include a plurality of RNN cells 31 to 34, and each of the RNN cells 31 to 34 may have an RNN structure which is mainly used for a neural network-based language model. The RNN block 130 may be replaced by another neural network model such as a transformer.

An output value of each RNN cell may denote a hidden value which is used as an input value of a softmax in the neural network-based language model.

According to the present embodiment, adversarial training or adversarial learning may be performed by using a hidden value (êᵢ) with an adversarial perturbation value reflected therein.

In order to perform adversarial learning, the present invention may estimate and calculate the adversarial perturbation value (êᵢ, rᵢ^{adv}) and may add the adversarial perturbation value to the input word embedding value (wᵢ₋₁) and the target word embedding value (wᵢ).

The adversarial learning may be classified into a decoding process of estimating an adversarial perturbation value and a learning process of performing a decoding process on the basis of the estimated adversarial perturbation value.

The decoding process of estimating the adversarial perturbation value may be a process of performing decoding inference or an RNN operation to generate an initial hidden value, without the adversarial perturbation value, and estimating the initial hidden value as the adversarial perturbation value.

A learning process based on the estimated adversarial perturbation value may include a process of adding the estimated adversarial perturbation value to the input word embedding value (wᵢ₋₁) and the target word embedding value (wᵢ) of an input terminal.

The decoder 100 may be learned so that a distance between hidden value (êᵢ) and the target word embedding value (wᵢ^{adv}) is minimized. Such learning may be performed by distance minimization calculator 150.

A learning method performed to minimize a distance value between two vector values (êᵢ) and (wᵢ^{adv}) may be based on a learning method based on a continuous output value described in the Kumar's paper, instead of a learning method using conventional softmax.

The Kumar's paper has proposed various loss functions based on the distance value between two vector values (êᵢ) and (wᵢ^{adv}). In the Kumar's paper, because a target word embedding value is assumed to be a pre-learned word embedding value, there is a problem in that a meaning variation based on a context is not considered.

In order to solve such a problem, the present invention may propose an access method (a learning method) where the self-attention model 140 projects context information, representing the meaning variation based on the context, onto the vector value (êᵢ) and minimizes a distance value between the vector value (êᵢ) with the context information projected thereon and the target word embedding value (wᵢ^{adv}) with the adversarial perturbation value reflected therein, for using a word embedding value with the meaning variation based on the context reflected therein.

The access method (the learning method) according to an embodiment of the present invention may be described as a loss function of machine learning based on a vector distance, and a detailed access method will be described as two portions. A first method may be a learning function using a distance between two vectors on the basis of adversarial vMF loss, and a second method may be a deep residual attention model.

Adversarial vMF Loss

The Kumar's paper describes a loss function such as the following Equation 1 by using a von Mises-Fisher (vMF) distribution, for calculating similarity between two word embedding vectors.

NLLvMF(ê;e(w))=−log(Cₘ(∥ê∥))−ê^{T}e(w) [Equation 1]

Equation 1 may have a function which decreases loss as similarity between a target word embedding value e(w) and an RNN output value ê increases, by using a negative log-likelihood of the vMF distribution.

Here, Cₘ(∥ê∥) may denote a concentration constant. When ∥ê∥ is close to 0, Cₘ(∥ê∥) may denote a uniform distribution, and when ∥ê∥=∞, Cₘ(∥ê∥) may denote a point distribution.

The Kumar's paper has proposed two heuristic regularization access method, but the present invention may apply an adversarial learning technique to the loss function “NLLvMF( )”.

In the Kumar's paper, because there is no softmax layer, the adversarial learning technique may not directly be applied to the loss function “NLLvMF( )”.

Therefore, the present invention may correct the loss function “NLLvMF( )” on the basis of the fast gradient sign method (FGSM) described in the Goodfellow's paper. Therefore, adversarial data may be generated by linearly moving input data in a gradient direction of the loss function “NLLvMF( )”, and thus, the robustness of a model may be reinforced.

Language generation learning may be based on the following Equation 2.

$${min}_{θ} {max}_{\{ {r}_{j \text{:} t , l} \}} {\sum }_{t , l} - log p ( {x}_{t}^{l} \vert {x}_{1 \text{:} t - 1}^{l} \text{;} θ , \{ {w}_{j} + {r}_{j} \} ) \qquad [ Equation 2 ]$$

According to the language generation learning based on Equation 2, when a context “x_{1:t-1}” is assumed, learning may be performed so that a negative log-likelihood of xₜ is minimized. Here, wⱼ may denote a word embedding value of xₜ, and rⱼ may denote a perturbation value of a corresponding embedding value. Here, rⱼ may be maximized so that adversarial noise is generated. Also, l may denote a sentence index.

A maximization value of an adversarial perturbation value in Equation 2 may be as expressed in the following Equation 3. Equation 3 may include content where a corresponding language generation model is described as NLLvMF.

$$\begin{matrix}ℒ := {max}_{\{ {r}_{j \text{:} t , l} \}} {\sum }_{t , l} - log p ( {x}_{t}^{l} \vert {x}_{1 \text{:} t - 1}^{l} \text{;} θ , \{ {w}_{j} + {r}_{j} \} ) \\ := {max}_{\{ {r}_{j \text{:} t , l} \}} {\sum }_{t , l} NLLvMF ( {\hat{e}}_{t}^{l} \text{;} θ , \{ {w}_{j} + {r}_{j} \} ) \\ := {max}_{\{ {r}_{j \text{:} t , l} \}} {\sum }_{t , l} - log ( {C}_{m} ( ‖ {\hat{e}}_{t}^{l} ‖ ) ) - {\hat{e}}_{t}^{l} \cdot ( {w}_{j} + {r}_{j} )\end{matrix} \qquad [ Equation 3 ]$$

The following Equation 4 may represent an estimated perturbation value.

$${r}_{j}^{*} = {arg max}_{‖ {r}_{j} ‖ \leq ϵ} NLLvMF ( \hat{e} \text{;} {w}_{j} + {r}_{j} ) = - ϵ \hat{e} \text{/} ‖ \hat{e} ‖ \qquad [ Equation 4 ]$$

Equation 4 may be configured with an output value of the decoder 100 and may have a regularization form. NLLvMF may represent a distance between the output value of the decoder 100 and a target embedding value, and Equation 4 may be for calculating an rⱼ value which allows a corresponding distance value to increase up to a certain level.

$$NLLvMF ( \hat{e} \text{;} {w}_{j} + {r}_{j} ) := - log ( {C}_{m} ( ‖ {\hat{e}}_{adv} ‖ ) ) - {\hat{e}}_{adv} \cdot {w}_{j} + ϵ {\hat{e}}_{adv}^{T} \cdot \frac{\hat{e}}{‖ \hat{e} ‖} \qquad [ Equation 5 ]$$

The Kumar's paper describes a heuristic access method which controls a learning process on the basis of a magnitude of a hidden value, but the present invention may apply adversarial learning to the loss function “NLLvMF( )” by using an estimated adversarial perturbation value.

Self-Attention Model

The present invention may have a large difference with the Kumar's paper in that, before comparing an output value of an RNN with a target word vector (a distance minimization process), the self-attention model (140 of FIG. 2) reflects or projects context information in or onto the output value ê of the RNN.

The present invention may perform a self-attention operation on output values ê of an output sentence (an RNN block 132) of an RNN by using the multi-head attention described in the Vaswani's paper.

In order to perform the self-attention operation, the self-attention model 140 illustrated in FIG. 2 may first project a current context (an input word embedding sequence: w₀, w₁ . . . wᵢ₋₁ . . . wₙ₋₁) to convert the current context into Q (Query), K (Key), and V (Value) matrixes.

The projection may be a process of converting the output values 132 (a word embedding sequence (column) of the RNN block 130 into the Q matrix configured with a parameter Q (Query), the K matrix configured with a parameter K (Key), and the V matrix configured with a parameter V (Value).

Subsequently, the self-attention model 140 may calculate a probability value representing similarity between a current word and context words by using softmax, based on a dot product performed on the Q matrix and the K matrix.

The context word may denote peripheral words of a current word and may denote previous words and next words with respect to the current word. Therefore, the context word may include similarity between the current word and the context words, similarity between the current word and the previous word, and similarity between the current word and the next word.

For example, the output values (the word embedding sequence) of the RNN block 130 may be assumed to be êᵢ₋₁, êᵢ, and êᵢ₊₁, and when a current word (a word corresponding to a current self-attention operation target) is êᵢ, a previous word is êᵢ₋₁, and a next word is êᵢ₊₁, similarity between the current word and context words may include similarity between êᵢ₋₁ and êᵢ and similarity between êᵢ and êᵢ₊₁.

Subsequently, the self-attention model 140 may merge (summate) word embedding values V of the context words by using the calculated probability value (similarity) as a weight value, and based thereon, may calculate an attention value. For example, when a probability value representing similarity between êᵢ and êᵢ₋₁ is a, a probability value representing similarity between êᵢ₊₁ and êᵢ is c, and a probability value representing similarity êᵢ between and each of êᵢ₋₁ and êᵢ₊₁ is b (=a+c), an attention concentration value corresponding to the current word may be calculated as “a*êᵢ₋₁+b*êᵢ₊c*êᵢ₊₁”.

Subsequently, the self-attention model 140 may summate the calculated attention value and a previous vector value and may perform a regularization process on the previous vector value and a summated attention value. Here, the previous vector value may denote hidden values 132 (a word embedding sequence) in which an adversarial perturbation value output from the RNN block 130 is reflected.

The self-attention model 140 may calculate a new vector value (i.e., a new hidden value (142 of FIG. 2) with context information reflected (projected thereon) therein) with self-attention reflected therein through the regularization process and may transfer the new hidden value 142 to the distance minimization calculator 150.

Multi-head attention may enhance attention performance through projections requiring a plurality of different learnings. Here, an updated vector value (i.e., the new hidden value 142) may be used to minimize a distance to a target embedding vector.

Experiment Result of the Present Invention

An experiment performed on an embodiment of the present invention has been performed based on French/English machine translation. An evaluation set has used an evaluation set of International Workshop on Spoken Language Translation (IWSLT16), and the evaluation set of IWSLT16 consists of 40,000 words and 2,369 sentence pairs.

A learning set has used parallel texts of 38,300 words and 220,000 sentences in English and parallel texts of 392,000 words and 220,000 sentences in French. In word embedding, a result learned based on fastText has be used.

Corresponding resources has used a result provided based on the Kumar's paper.

The following Table 1 shows six experiment results. IN-adv is an experiment where a perturbation value is applied, and OUT-adv is an experiment where the perturbation value is applied to an output layer.

ATT is an experiment with a self-attention model applied thereto. In results of the experiments, OUT-adv which is an experiment where the perturbation value is applied to an output layer shows a best result.

TABLE 1

| | Experiment | Experiment | Experiment | |
|---|---|---|---|---|
| | 1 | 2 | 3 | Average |
| Baseline [1] | 30.59 | 30.08 | 30.25 | 30.31 |
| IN-adv | 30.26 | 30.74 | 30.48 | 30.49 |
| OUT-adv | 30.5 | 30.41 | 30.78 | 30.56 |
| IN-OUT | 30.47 | 30.29 | 30.15 | 30.30 |
| ATT | 30.31 | 30.44 | 30.36 | 30.37 |
| IN-adv + ATT | 30.15 | 30.02 | 30.13 | 30.1 |

As described above, an evaluation result according to an embodiment of the present invention is best in an experiment where adversarial learning is applied to an output terminal of a decoder, but when an adversarial learning method is applied to all of an input terminal and an output terminal, the same result or a better result is expected to be obtained.

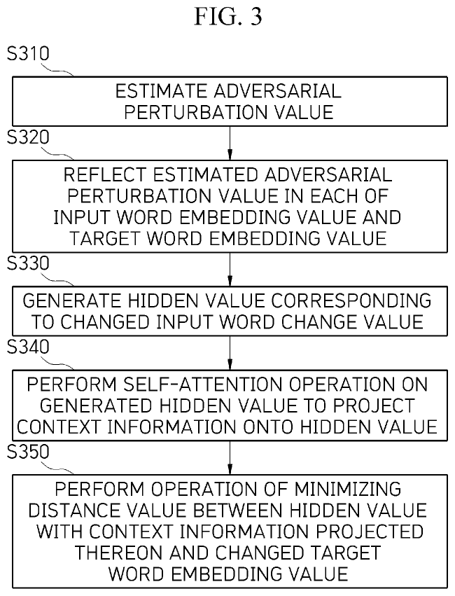

FIG. 3 is a flowchart for describing a learning method of a neural network model for language generation, according to an embodiment of the present invention.

The learning method of the neural network model for language generation according to an embodiment of the present invention may be performed by a computing device and at least one processor (for example, a CPU and a GPU) of the computing device.

Referring to FIG. 3, in step 320, the adder block 110 may perform a process of respectively adding adversarial perturbation values (for example, rᵢ₋₁^{adv} and rᵢ^{adv} in FIG. 2) to an input word embedding value (for example, wᵢ₋₁ of FIG. 2), where an input word is expressed as a vector, and a target word embedding value (for example, wᵢ of FIG. 2) where a right answer word appearing next to the input word is expressed as a vector.

Before step 320, in step 310, a process of calculating (estimating) an adversarial perturbation value may be performed for summating the word embedding values (for example, wᵢ₋₁ and wᵢ of FIG. 2) and the adversarial perturbation values (for example, rᵢ₋₁^{adv} and rᵢ^{adv} in FIG. 2).

Here, the adversarial perturbation values (for example, rᵢ₋₁^{adv} and rᵢ^{adv} in FIG. 2) may allow a distance value between a value, obtained by converting the input word embedding value (for example, wᵢ₋₁ of FIG. 2) through an RNN, and the target word embedding value (for example, wᵢ of FIG. 2) to be converted into a value corresponding to a certain level or more. That is, the adversarial perturbation values (for example, rᵢ₋₁^{adv} and rᵢ^{adv} in FIG. 2) may be used as information for intentionally decreasing similarity between the input word embedding value (for example, wᵢ₋₁ of FIG. 2) and the target word embedding value (for example, wᵢ of FIG. 2).

The process of calculating (estimating) the adversarial perturbation values (for example, rᵢ₋₁^{adv} and rᵢ^{adv} in FIG. 2) may be performed by the RNN block 130. In order to calculate (estimate) the adversarial perturbation value, the adder block 110 may first perform a process of inputting the input word embedding value (for example, wᵢ₋₁ of FIG. 2) to the RNN block 130 without performing an addition operation on the input word embedding value (for example, wᵢ₋₁ of FIG. 2).

Subsequently, the RNN block 130 may perform a process of performing an RNN operation on the input word embedding value (for example, wᵢ₋₁ of FIG. 2) input from the adder block 110 to calculate an initial hidden value and calculating the calculated initial hidden value as the adversarial perturbation values (for example, rᵢ₋₁^{adv} and rᵢ^{adv} in FIG. 2).

When the calculation of the adversarial perturbation values (for example, rᵢ₋₁^{adv} and rᵢ^{adv} in FIG. 2) is completed in step 310, the calculated adversarial perturbation values may be fed back to the adder blocks 110 and 120, and the adder blocks 110 and 120 may perform a process of adding the adversarial perturbation values (for example, rᵢ₋₁^{adv} and rᵢ^{adv} in FIG. 2), fed back from the RNN block 120, to the input word embedding value (for example, wᵢ₋₁ of FIG. 2) and the target word embedding value (for example, wᵢ of FIG. 2).

Subsequently, in step 330, the RNN block 130 may perform a process of performing an RNN operation on an input word embedding value with the adversarial perturbation value added thereto to calculate a hidden value (for example, êᵢ of FIG. 2).

Subsequently, in step 340, the self-attention model 140 may perform a self-attention operation on the hidden value (for example, êᵢ of FIG. 2) which is calculated in step 330, and thus, a process of projecting (applying) context information about a peripheral word of the input word onto (to) the calculated hidden value may be performed. Here, the self-attention operation may be, for example, a multi-head attention operation.

In order to perform a self-attention operation of projecting (applying) the context information about the peripheral word onto (to) the calculated hidden value (for example, êᵢ of FIG. 2), the adder block 110 may first perform a process of summating peripheral word embedding values (for example, w₀, w₁, and wₙ₋₁ of FIG. 2) corresponding to the peripheral word of the input word and adversarial perturbation values (r₀^{adv}, r₁^{adv}, and rₙ₋₁^{adv}) corresponding to the peripheral word embedding values (for example, w₀, w₁, and wₙ₋₁ of FIG. 2) and a process of performing an RNN operation on a peripheral word embedding value added to the corresponding adversarial perturbation value by the RNN block 130 to calculate peripheral hidden values (ê₁, ê₂, and êₙ of FIG. 2).

When the calculation of the peripheral hidden values (ê₁, ê₂, and êₙ of FIG. 2) is completed, a self-attention operation (step 340) of applying (projecting) the calculated peripheral hidden values (ê₁, ê₂, and êₙ of FIG. 2) to (onto) the calculated hidden value (êᵢ of FIG. 2) by using the calculated peripheral hidden values (ê₁, ê₂, and êₙ of FIG. 2) as the context information may be performed.

Here, the peripheral word may include a previous word and a next word with respect to the input word corresponding to a self-attention operation target, and the peripheral word embedding value may include previous word embedding values (w₀ and w₁ of FIG. 2) corresponding to the previous word and a next word embedding value (Wₙ₋₁ of FIG. 2) corresponding to the next word.

The peripheral hidden value may include previous hidden values and of FIG. 2) corresponding to the previous word embedding values (w₀ and w₁ of FIG. 2) and a next hidden value (êₙ of FIG. 2) corresponding to the next word embedding value (Wₙ₋₁ of FIG. 2). In this case, the previous hidden values (i and of FIG. 2) and the next word embedding value (Wₙ₋₁ of FIG. 2) may be values to which adversarial perturbation values are respectively applied by the adder block 110.

A process of projecting the calculated peripheral hidden values (ê₁, ê₂, and êₙ of FIG. 2) onto the calculated hidden value (êᵢ of FIG. 2) will be described in more detail.

First, a process of calculating a probability value representing the degree of similarity between the calculated peripheral hidden values (ê₁, ê₂, and êₙ of FIG. 2) and the calculated hidden value (êᵢ of FIG. 2) may be performed. For example, the probability value may include similarity between ê₁ and êᵢ, similarity between ê₂ and êᵢ, and similarity between êᵢ and êₙ.

In calculating a probability value representing similarity, as described above, output values (word embedding sequence: ê₁, ê₂, êᵢ, êₙ) of the RNN block 130 may be converted into the Q matrix configured with a parameter Q (Query), the K matrix configured with a parameter K (Key), and the V matrix configured with a parameter V (Value), and then, a probability value representing similarity between a current word (current hidden value: êᵢ of FIG. 2) and context words (peripheral hidden values: ê₁, ê₂, and êₙ of FIG. 2) may be calculated through a dot product performed on the Q matrix and the K matrix.

Subsequently, the calculated peripheral hidden values (ê₁, ê₂, and êₙ of FIG. 2) (i.e., context information) may be projected onto the calculated hidden value (êᵢ of FIG. 2) through a process of regularizing an addition result obtained by summating the calculated peripheral hidden values (ê₁, ê₂, and êₙ of FIG. 2) and the calculated hidden value (êᵢ of FIG. 2) by using the probability value as a weight value.

Subsequently, in step 350, the distance minimization calculator 150 may perform a process of minimizing a distance value between a hidden value with the context information projected thereon and a target word embedding value with the adversarial perturbation value added thereto, for performing adversarial learning on the neural network model.

The process of minimizing the distance value between the hidden value with the context information projected thereon and the target word embedding value may be performed by using, for example, a negative log-likelihood of a loss function. Here, the loss function may be a function associated with (representing) a vMF distribution.

Each step included in the learning method described above may be implemented as a software module, a hardware module, or a combination thereof, which is executed by a computing device.

Also, an element for performing each step, an adder block, an RNN block, a self-attention model, and a distance minimization calculator may be respectively implemented as first to fourth operational logics of a processor.

The software module may be provided in RAM, flash memory, ROM, erasable programmable read only memory (EPROM), electrical erasable programmable read only memory (EEPROM), a register, a hard disk, an attachable/detachable disk, or a storage medium (i.e., a memory and/or a storage) such as CD-ROM.

An exemplary storage medium may be coupled to the processor, and the processor may read out information from the storage medium and may write information in the storage medium. In other embodiments, the storage medium may be provided as one body with the processor.

The processor and the storage medium may be provided in application specific integrated circuit (ASIC). The ASIC may be provided in a user terminal. In other embodiments, the processor and the storage medium may be provided as individual components in a user terminal.

Exemplary methods according to embodiments may be expressed as a series of operation for clarity of description, but such a step does not limit a sequence in which operations are performed. Depending on the case, steps may be performed simultaneously or in different sequences.

In order to implement a method according to embodiments, a disclosed step may additionally include another step, include steps other than some steps, or include another additional step other than some steps.

Various embodiments of the present disclosure do not list all available combinations but are for describing a representative aspect of the present disclosure, and descriptions of various embodiments may be applied independently or may be applied through a combination of two or more.

Moreover, various embodiments of the present disclosure may be implemented with hardware, firmware, software, or a combination thereof. In a case where various embodiments of the present disclosure are implemented with hardware, various embodiments of the present disclosure may be implemented with one or more application specific integrated circuits (ASICs), digital signal processors (DSPs), digital signal processing devices (DSPDs), programmable logic devices (PLDs), field programmable gate arrays (FPGAs), general processors, controllers, microcontrollers, or microprocessors.

The scope of the present disclosure may include software or machine-executable instructions (for example, an operation system (OS), applications, firmware, programs, etc.), which enable operations of a method according to various embodiments to be executed in a device or a computer, and a non-transitory computer-readable medium capable of being executed in a device or a computer each storing the software or the instructions.

According to the embodiments of the present invention, because a softmax operation is avoided, a learning speed of a neural network model for neural network-based language generation may be effectively improved.

Moreover, the neural network model for neural network-based language generation according to the embodiments of the present invention may provide a technique for reflecting a context at a time at which a target word vector is compared with an output vector, thereby enabling generating of a multi-meaning vocabulary.

Moreover, according to the embodiments of the present invention, the robustness of the neural network model for neural network-based language generation may be enhanced by using an adversarial training technique, thereby improving an expressive power of the neural network model.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A learning method of a neural network model for language generation, performed by at least one processor of a computing device, the learning method comprising:
adding, by using an adder block, an adversarial perturbation value to each of an input word embedding value, where an input word is expressed as a vector, and a target word embedding value where a right answer word appearing next to the input word is expressed as a vector;
performing, by using a recurrent neural network (RNN) block, an RNN operation on an input word embedding value with the adversarial perturbation value added thereto to calculate a hidden value;
performing, by using a self-attention model, a self-attention operation on the calculated hidden value to project context information about a peripheral word of the input word onto the calculated hidden value; and
performing, by using a distance minimization calculator, adversarial learning on the neural network model through an operation of minimizing a distance value between a hidden value with the context information projected thereon and a target word embedding value with the adversarial perturbation value added thereto.

2. The learning method of claim 1, further comprising, before the adding, estimating the adversarial perturbation value allowing a distance value between a distance value between a value, obtained by converting the input word embedding value through an RNN, and the target word embedding value to be converted into a value corresponding to a certain level or more by using the RNN block.

3. The learning method of claim 2, wherein the estimating of the adversarial perturbation value comprises:
outputting, by using the adder block, the input word embedding value to the RNN block without adding the adversarial perturbation value; and
performing, by using the RNN block, an RNN operation on the input word embedding value to calculate an initial hidden value and estimating the calculated initial hidden value as the adversarial perturbation value.

4. The learning method of claim 1, further comprising:
summating, by using the adder block, a peripheral word embedding value corresponding to the peripheral word of the input word and an adversarial perturbation value corresponding to the peripheral word embedding value; and
performing, by using the RNN block, an RNN operation on a peripheral word embedding value with the corresponding adversarial perturbation value added thereto to calculate a peripheral hidden value,
wherein the projecting of the context information comprises projecting the calculated peripheral hidden value onto the calculated hidden value by using the calculated peripheral hidden value as the context information.

5. The learning method of claim 4, wherein the projecting of the calculated peripheral hidden value comprises:
calculating a probability value representing a degree of similarity between the calculated peripheral hidden value and the calculated hidden value;
summating the calculated peripheral hidden value and the calculated hidden value by using the probability value as a weight value; and
regularizing an addition result obtained by summating the calculated peripheral hidden value and the calculated hidden value to project the calculated peripheral hidden value onto the calculated hidden value.

6. The learning method of claim 1, wherein the performing of the adversarial learning comprises performing adversarial learning on the neural network model by performing an operation of minimizing a distance value between a hidden value with the context information projected thereon and a target word embedding value with the adversarial perturbation value added thereto by using a negative log-likelihood of a loss function.

7. The learning method of claim 6, wherein the loss function is a function associated with a von Mises-Fisher (vMF) distribution.

8. The learning method of claim 1, wherein the self-attention operation is a multi-head attention operation.

9. The learning method of claim 1, wherein
the neural network model is a sequence-to-sequence model including an encoder and a decoder, and
the performing of the adversarial learning comprises performing the adversarial learning on the decoder.

10. A computing device for performing learning of a neural network model, the computing device comprising:
a storage medium storing the neural network model; and
a processor connected to the storage medium to execute the neural network model stored in the storage medium,
wherein the processor comprises:
a first operational logic adding an adversarial perturbation value to each of an input word embedding value, where an input word is expressed as a vector, and a target word embedding value where a right answer word appearing next to the input word is expressed as a vector;
a second operational logic performing a recurrent neural network (RNN) operation on an input word embedding value with the adversarial perturbation value added thereto to calculate a hidden value;
a third operational logic performing a self-attention operation on the calculated hidden value to project context information about a peripheral word of the input word onto the calculated hidden value; and
a fourth operational logic performing adversarial learning on the neural network model through an operation of minimizing a distance value between a hidden value with the context information projected thereon and a target word embedding value with the adversarial perturbation value added thereto.

11. The computing device of claim 10, wherein the second operational logic calculates the adversarial perturbation value where a distance value between a distance value between a value, obtained by converting the input word embedding value through an RNN, and the target word embedding value is set to a certain level.

12. The computing device of claim 10, wherein the second operational logic performs an RNN operation on the input word embedding value, to which the adversarial perturbation value is not added, to calculate an initial hidden value and generates the calculated initial hidden value as the adversarial perturbation value.

13. The computing device of claim 10, wherein
the first operational logic summates a peripheral word embedding value corresponding to the peripheral word of the input word and an adversarial perturbation value corresponding to the peripheral word embedding value,
the second operational logic performs an RNN operation on a peripheral word embedding value with the corresponding adversarial perturbation value added thereto to calculate a peripheral hidden value, and
the third operation logic performs an operation of projecting the calculated peripheral hidden value onto the calculated hidden value by using the calculated peripheral hidden value as the context information.

14. The computing device of claim 13, wherein the third operational logic calculates a probability value representing a degree of similarity between the calculated peripheral hidden value and the calculated hidden value, summates the calculated peripheral hidden value and the calculated hidden value by using the probability value as a weight value, and regularizes an addition result obtained by summating the calculated peripheral hidden value and the calculated hidden value.

15. The computing device of claim 10, wherein the fourth operational logic performs an operation of minimizing a distance value between a hidden value with the context information projected thereon and a target word embedding value with the adversarial perturbation value added thereto by using a negative log-likelihood of a von Mises-Fisher (vMF) distribution, for performing adversarial learning on the neural network model.
